(19) United States
(12) Patent Application Publication
(10) Pub. No.: US 2006/0267524 A1
(43) Pub. Date: Nov. 30, 2006

(54) Controller for remote-control toy airplane

(76) Inventor: Chi-Shin Chang, Taya Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/135,516

(22) Filed: May 24, 2005

(51) Int. Cl. H02K 1/00

(52) U.S. Cl. 318/16

(57) ABSTRACT

A controller for use in a remote control toy airplane is disclosed to include a booster circuit for boosting the voltage of the battery of the remote control toy airplane to the desired voltage level for the working of the motor of the remote control toy airplane, and an electronic speed-change control circuit for controlling output voltage and current from the battery to the motor of the remote control toy airplane subject to the nature of the wireless control signal received from a wireless receiver.

### BACKGROUND OF THE INVENTION

1. Field of the Invention

The present invention relates a remote control toy airplane and more specifically, to a controller for controlling the operation of a remote control toy airplane.

Various remote control toy airplanes are commercially available. These conventional remote control toy airplanes have common drawbacks as follows:

1. These conventional remote control toy airplanes commonly consume 4.8 V˜6 V DC, i.e., at least 4 pieces of battery cells are needed. When considering the problem of “voltage drop”, 6˜8 pieces of battery cells are required. This big number of battery cells greatly increases the weight of the respective remote control toy airplane, thereby affecting the endurance, speed and activeness of the remote control toy airplane.

2. These conventional remote control toy airplanes commonly use a variable resistor to control the speed of the motor of the respective remote control toy airplane. This speed control method is less accurate and the reaction speed is low.

### SUMMARY OF THE INVENTION

The present invention has been accomplished under the circumstances in view. It is one object of the present invention to provide a controller for remote control toy airplane, which saves the amount of battery cells required for the working of the remote control toy airplane. It is another object of the present invention to provide a controller for remote control toy airplane, which controls the speed of the motor of the remote control toy airplane rapidly and accurately. To achieve these and other objects of the present invention, the controller comprises a booster circuit for boosting the voltage of the battery of the remote control toy airplane to the desired voltage level for the working of the motor of the remote control toy airplane, and an electronic speed-change control circuit for controlling output voltage and current from the battery to the motor of the remote control toy airplane subject to the nature of the wireless control signal received from a wireless receiver.

### BRIEF DESCRIPTION OF THE DRAWINGS

FIG. 1 is a circuit diagram of a controller for remote control toy airplane according to the present invention.

FIG. 2 is a system block diagram of the present invention.

### DETAILED DESCRIPTION OF THE PREFERRED EMBODIMENT

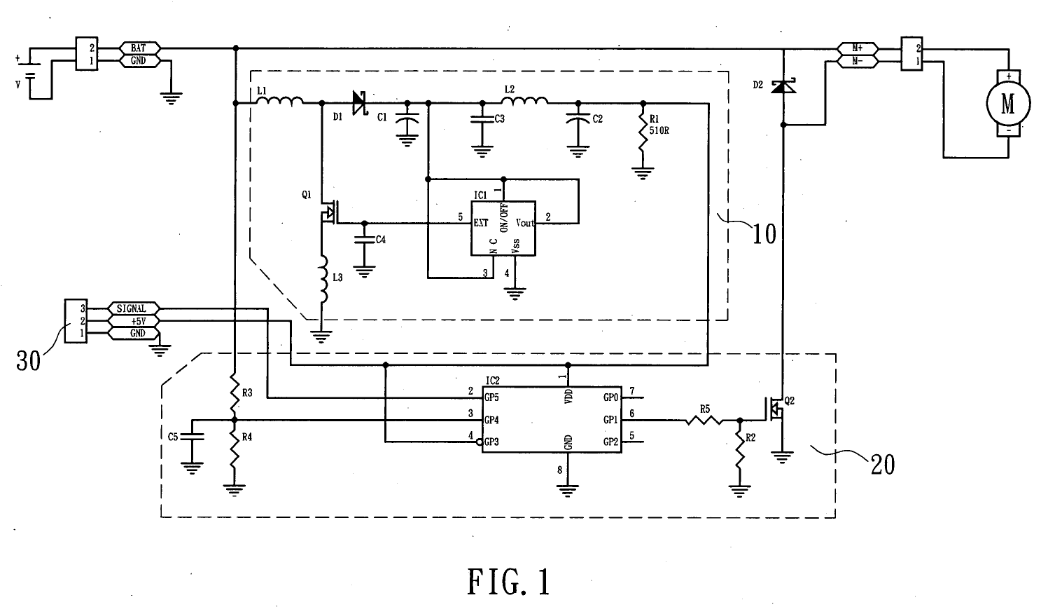

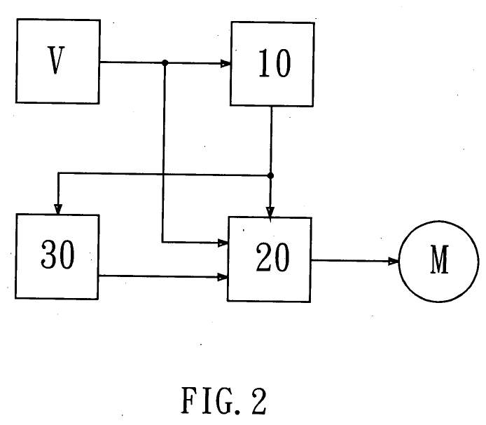

Referring to FIGS. 1 and 2, a controller in accordance with the present invention is shown electrically connected to the motor M of a remote control toy airplane (not shown). The controller comprises a booster circuit 10, and an electronic speed-change control circuit 20.

The booster circuit 10 is comprised of a booster chip IC1, a thyrister Q1, inductors L1˜L3, capacitors C1˜C3, and a resistor R1. The booster circuit 10 is electrically connected between the battery V and motor M of the remote control toy air plane to be controlled, and adapted to boost 2.4 V battery power to 4.8 V or the desired voltage level for the working of the remote control toy airplane.

The electronic speed-change control circuit 20 is comprised of a CPU IC2, a thyrister Q2, a capacitor C5, and resistors R2˜R5. The electronic speed-change control circuit 20 is electrically connected between a wireless receiver 30 and the motor M, and adapted to receive a wireless control signal and to control output voltage and current to the motor M subject to the nature of the received wireless control signal.

As indicated above, the booster circuit 10 is comprised of a booster chip IC1, a thyrister Q1, inductors L1˜L3, capacitors C1˜C3, and a resistor R1. The booster circuit 10 boosts 2.4 V battery power to 4.8 V for the working of the remote control toy airplane. The use of the booster circuit 10 can greatly save the amount of battery cells, thereby reducing the weight of battery cells. For example, two pieces of 1.2 V 28 g battery cells can be used with the booster circuit 10 to provide the remote control toy airplane with sufficient working power, and four pieces of 1.2 V 28 g battery cells are needed for the working of the remote control toy airplane according to the prior art design. Therefore, the invention saves much battery installation space, reduces much the total weight of the remote control toy airplane, enabling the remote control toy airplane to fly longer and farther.

Further, as shown in FIG. 1, the CPU IC2 of the electronic speed-change control circuit 20 receives wireless start, take-off, lifting, turning, landing control signals, and controls the output of voltage and current to the motor M through the thyrister Q2 so as to further control the speed of the motor M subject to the nature of the received control signal.

A prototype of controller for remote control toy airplane has been constructed with the features of FIGS. 1 and 2. The controller for remote control toy airplane functions smoothly to provide all the features discussed earlier.

Although a particular embodiment of the invention had been described in detail for purposes of illustration, various modifications and enhancements may be made without departing from the spirit and scope of the invention. Accordingly, the invention is not to be limited except as by the appended claims.

What the invention claimed is:

1. A controller comprising a booster circuit and an electronic speed-change control circuit and used in a remote control toy airplane and electrically connected to a motor of said remote control toy airplane and adapted to control the operation of said motor subject to an external wireless control signal, wherein said booster circuit comprises a booster chip, a thyrister, a plurality of inductors, a plurality of capacitors and a resistor, and is electrically connected between a 2.4 V battery power supply of said remote control toy airplane and said motor for boosting 2.4 V battery power to 4.8 V for the working of said motor.

2. The controller as claimed in claim 1, wherein said electronic speed-change control circuit comprises a CPU, a thyrister, a capacitor and a plurality of resistors, and is electrically connected between a wireless receiver and said motor for receiving a wireless control signal and controlling output voltage and current from said 2.4 V battery power supply to said motor subject to the nature of the received wireless control signal.
